(19) United States
(12) Patent Application Publication
(10) Pub. No.: US 2026/0032673 A1
(43) Pub. Date: Jan. 29, 2026

(54) NARROWBAND INTERNET OF THINGS NARROWBAND PHYSICAL UPLINK SHARED CHANNEL ORTHOGONAL COVER CODE (OCC) SUPPORT AND SCHEDULING WITH OCC INDEX INDICATION

(71) Applicant: Sharp Kabushiki Kaisha, Sakai City (JP)

(72) Inventors: Zhanping Yin, Vancouver, WA (US); Tomoki Yoshimura, Camas, WA (US)

(21) Appl. No.: 18/783,176

(22) Filed: Jul. 24, 2024

(51) Int. Cl. H04W 72/1268; H04J 13/00; H04L 1/00; H04W 72/231; H04W 84/06

(52) U.S. Cl. CPC H04W 72/1268; H04J 13/004; H04L 1/0061; H04W 72/231; H04W 84/06

(57) ABSTRACT

An internet of things (IoT) non-terrestrial network (NTN) device user equipment (UE) is described. The UE includes receiving circuitry configured to receive configurations on orthogonal cover code (OCC) multiplexing support and OCC multiplexing factor for narrowband internet of things (NB-IoT) narrowband physical uplink shared channel (NPUSCH) in a higher layer signaling. The receiving circuitry is also configured to receive a separately configured orthogonal cover code radio network temporary identifier (OCC-RNTI) and/or a number of repetitions table for a repetition number field in downlink control information (DCI) format 0 and to receive a DCI format N0 for a NPUSCH transmission with an OCC index indication. The UE also includes transmitting circuitry configured to transmit an NPUSCH with OCC multiplexing with the provided OCC multiplexing factor and the indicated OCC index on a schedule resource.

### TECHNICAL FIELD

The present disclosure relates generally to communication systems. More specifically, the present disclosure relates to systems and methods for Narrowband Internet of Things (NB-IoT) Narrowband Physical Uplink Shared Channel (NPUSCH) Orthogonal Cover Code (OCC) support and scheduling with OCC index indication.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a diagram illustrating an example of a non-terrestrial network (NTN) coverage area;

FIG. 2 is a table illustrating an example of fields in DCI format N0;

FIG. 3 is a table illustrating an example of allocated subcarriers for NPUSCH with Δf=15 kHz;

FIG. 4 includes two tables illustrating an example of how the subcarrier indication field in DCI format N0 specifies the specific subcarriers to allocate uplink (UL) resources;

FIG. 5 is a table illustrating an example of the number of repetitions for (N_{Rep}) NPUSCH;

FIG. 6 is a table illustrating an example of the scheduling delay field and the DCI subframe repetition number field in DCI format N0;

FIG. 7 is a flow diagram illustrating an example of a method by a UE;

FIG. 8 is a flow diagram illustrating an example of a method by an eNB;

FIG. 9 is a flow diagram illustrating another example of a method by a UE;

FIG. 10 is a flow diagram illustrating another example of a method by an eNB;

FIG. 11 is a flow diagram illustrating a further example of a method by a UE;

FIG. 12 is a flow diagram illustrating a further example of a method by an eNB;

FIG. 13 is a diagram illustrating one implementation of a core network node;

FIG. 14 is a block diagram illustrating one implementation of a base station (eNB) in which the present systems and methods may be implemented;

FIG. 15 is a block diagram illustrating one implementation of a wireless terminal in which the present systems and methods may be implemented;

FIG. 16 illustrates various components that may be utilized in a wireless terminal in which the present systems and methods may be implemented;

FIG. 17 illustrates various components that may be utilized in an eNB in which the present systems and methods may be implemented;

FIG. 18 is a block diagram illustrating one implementation of a wireless terminal in which the present systems and methods may be implemented; and

FIG. 19 is a block diagram illustrating one implementation of a eNB in which the present systems and methods may be implemented.

### DETAILED DESCRIPTION

An internet of things (IoT) non-terrestrial network (NTN) device user equipment (UE) is described. The UE includes receiving circuitry configured to receive configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4. The receiving circuitry may also be configured to receive a separately configured orthogonal cover code radio network temporary identifier (OCC-RNTI) and/or a number of repetitions table for a repetition number field in downlink control information (DCI) format 0. The receiving circuitry may also be configured to receive a DCI format N0 for a NPUSCH transmission with an OCC index indication. The UE also includes transmitting circuitry configured to transmit a NPUSCH with OCC multiplexing with the provided OCC multiplexing factor and the indicated OCC index on a schedule resource.

In some examples, if the OCC multiplexing factor is 2, the OCC index may be provided by the two most significant bits in a subcarrier indication field, with 00 for OCC index 0 and 11 for OCC index 1. In other examples, if the OCC multiplexing factor is 2, the OCC index may be provided by the most significant bits in the subcarrier indication field, with 0 for OCC index 0 and 1 for OCC index 1.

In another example, if the OCC multiplexing factor is 2 and if separately configured number of repetitions table comprises 4 entries, the OCC index may be provided by the most significant bits in the repetition number field, with 0 for OCC index 0 and 1 for OCC index 1. In a yet further example, if the OCC multiplexing factor is 2 and if a separate OCC-RNTI is configured, an OCC index 0 may be indicated by scrambling a cyclic redundancy check (CRC) with a legacy cell radio network temporary identifier (C-RNTI) in the DCI format N0, and an OCC index 1 is indicated by scrambling the CRC with a new OCC-RNTI in the DCI format N0.

An e-NodeB (eNB) is described. The eNB may include transmitting circuitry configured to transmit to an internet of things (IoT) non-terrestrial network (NTN) device user equipment (UE) the configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4. The transmitting circuitry may also be configured to transmit configurations on a separately configured orthogonal cover code radio network temporary identifier (OCC-RNTI) and/or a number of repetitions table for a repetition number field in downlink control information (DCI) format 0. The transmitting circuitry may also be configured to transmit a DCI format NO for a NPUSCH transmission with an OCC index indication. The eNB also includes receiving circuitry configured to receive a NPUSCH with OCC multiplexing with the provided OCC multiplexing factor and the indicated OCC index on a schedule resource.

A method by an internet of things (IoT) non-terrestrial network (NTN) device user equipment (UE) is described. The method includes receiving configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4. The method also includes receiving a separately configured orthogonal cover code radio network temporary identifier (OCC-RNTI) and/or a number of repetitions table for a repetition number field in downlink control information (DCI) format 0. The method also includes receiving a DCI format N0 for a NPUSCH transmission with an OCC index indication. The method also includes transmitting an NPUSCH with OCC multiplexing with the provided OCC multiplexing factor and the indicated OCC index on a schedule resource.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a wireless terminal, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a wireless terminal. However, as the scope of the present disclosure should not be limited to the 3GPP standards, the terms “wireless terminal” and “wireless communication device” may be used interchangeably herein to mean the more general term “wireless communication device.” A wireless terminal may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a wireless terminal. It should also be noted that in E-UTRA and E-UTRAN overall description, as used herein, a “cell” may be defined as “combination of downlink and optionally uplink resources.” The linking between the carrier frequency of the downlink (DL) resources and the carrier frequency of the uplink resources may be indicated in the system information transmitted on the downlink resources.

“Configured cells” are those cells of which the wireless terminal is aware and is allowed by an eNB to transmit or receive information. “Configured cell(s)” may be serving cell(s). The wireless terminal may receive system information and perform the required measurements on all configured cells. “Configured cell(s)” for a radio connection may include a primary cell and/or no, one, or more secondary cell(s). “Activated cells” are those configured cells on which the wireless terminal is transmitting and receiving. That is, activated cells are those cells for which the wireless terminal monitors the physical downlink control channel (PDCCH) and in the case of a downlink transmission, those cells for which the wireless terminal decodes a physical downlink shared channel (PDSCH). “Deactivated cells” are those configured cells that the wireless terminal is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IOT)) but lower than URLLC and eMBB.

A non-terrestrial network (NTN) refers to a network, or segment of networks using radio frequency (RF) resources onboard a satellite (or UAS platform). Non-Terrestrial Network typically features the following elements: one or several sat-gateways that connect the Non-Terrestrial Network to a public data network. For example, a Geostationary Earth Orbiting (GEO) satellite is fed by one or several sat-gateways which are deployed across the satellite targeted coverage (e.g., regional or even continental coverage). It may be assumed that wireless terminals in a cell are served by only one sat-gateway. A Non-GEO satellite served successively by one or several sat-gateways at a time. The system ensures service and feeder link continuity between the successive serving sat-gateways with sufficient time duration to proceed with mobility anchoring and hand-over.

Additionally, Non-Terrestrial Network typically features the following elements: a Feeder link or radio link between a sat-gateway and the satellite (or Unmanned Aircraft System (UAS) platform), a service link or radio link between the wireless terminal and the satellite (or UAS platform).

Additionally, Non-Terrestrial Network typically features the following elements: a satellite (or UAS platform) which may implement either a transparent or a regenerative (with onboard processing) payload. The satellite (or Unmanned Aircraft System (UAS) platform) may generate several beams over a given service area bounded by its field of view. The footprints of the beams are typically of elliptic shape. The field of view of a satellite (or UAS platform) depends on the onboard antenna diagram and min elevation angle. For a transparent payload, radio frequency filtering, frequency conversion and amplification may be applied. Hence, the waveform signal repeated by the payload is un-changed. For a regenerative payload, radio frequency filtering, frequency conversion and amplification as well as demodulation/decoding, switch and/or routing, coding/modulation may be applied. This is effectively equivalent to having all or part of base station functions (e.g., gNB) onboard the satellite (or UAS platform).

Additionally, Non-Terrestrial Network may optionally feature the following elements: Inter-satellite links (ISL) optionally in case of a constellation of satellites. This will require regenerative payloads onboard the satellites. ISL may operate in RF frequency or optical bands.

Additionally, Non-Terrestrial Network typically features the following elements: User Equipment (UE) may be served by the satellite (or UAS platform) within the targeted service area.

There may be different types of satellites (or UAS platforms): Low-Earth Orbit (LEO) satellite, Medium-Earth Orbit (MEO) satellite, Geostationary Earth Orbit (GEO) satellite, UAS platform (including High-Altitude Platform Station (HAPS) and High Elliptical Orbit (HEO) satellite). Detailed descriptions are shown in Table 1.

TABLE 1

| | | | | Typical beam | |
|---|---|---|---|---|---|
| Platforms | Altitude range | | Orbit | footprint size | |
| Low-Earth Orbit (LEO) satellite | 300-1500 | km | Circular around the earth | 100-1000 | km |
| Medium-Earth Orbit (MEO) satellite | 7000-25000 | km | | 100-1000 | km |
| Geostationary Earth Orbit (GEO) satellite | 35 786 | km | Notional station keeping position fixed in | 200-3500 | km |
| UAS platform (including HAPS) | 8-50 km (20 | | terms of elevation/azimuth with respect | 5-200 | km |
| | km for HAPS) | | to a given earth point | | |
| High Elliptical Orbit (HEO) satellite | 400-50000 | km | Elliptical around the earth | 200-3500 | km |

Typically, GEO satellites and UAS are used to provide continental, regional or local service. A constellation of LEO and MEO may be used to provide services in both Northern and Southern hemispheres. In some cases, the constellation can even provide global coverage including polar regions. For the later, this requires appropriate orbit inclination, sufficient beams generated and inter-satellite links.

Non-terrestrial networks may provide access to wireless terminal in six reference scenarios including: Circular orbiting and notional station keeping platforms, highest round trip delay (RTD) constraint, highest Doppler constraint, a transparent and a regenerative payload, one ISL case and one without ISL (Regenerative payload is mandatory in the case of inter-satellite links), fixed or steerable beams resulting respectively in moving or fixed beam foot print on the ground.

The systems and methods described herein may be used to address the needs suggested by the following:

NPUSCH OCC is the key feature for uplink (UL) enhancement of IoT Non-Terrestrial Network (NTN).

Different OCC methods are considered, including intra-symbol, inter-symbol, inter-slot, inter-repetition, etc.

NPUSCH with OCC and NPUSCH without OCC may have different resource mapping and transport block segmentation methods. Thus, the UE should be indicated by the Next Generation Node B (gNB) on whether OCC is applied or not. Furthermore, the OCC multiplexing factor should be signaled if OCC is supported.

In one approach, the OCC method and OCC multiplexing factor (or OCC capacity or OCC length or OCC unit size, etc.) can be configured semi-statically by higher layer signaling, e.g. Radio Resource Control (RRC) signaling and/or Medium Access Control Control Element (MAC CE) indication. In this case, dynamic switching between NPUSCH with OCC and NPUSCH without OCC is not supported. The OCC index should be dynamically indicated in the scheduling Downlink Control Information (DCI).

On the other hand, the NPUSCH with OCC is more complicated than legacy NPUSCH without OCC, and the single IoT device performance may be degraded with OCC. Also, different OCC lengths can be used based on the paring conditions observed at the Evolved Node B (eNB). Thus, it may be beneficial to support dynamic scheduling of NPUSCH transmissions with or without OCC, and with different OCC lengths.

Regardless of what OCC method is employed or specified, the OCC multiplexing is supported for up to 4 UEs. How to indicate the OCC index in the UL grant should be specified if OCC is configured or indicated.
For NPUSCH, the OCC index should be dynamically indicated in the DCI format NO.
An IoT device has limited capabilities in Narrowband Physical Downlink Control Channel (NPDCCH) blind decoding; it is better to maintain the size of DCI format NO.
To keep the DCI format size, some bits from one or more fields may be re-purposed as OCC index indication.

Some general aspects of the systems and methods described below are as follows:

Semi-Static OCC Configuration with OCC Length, Dynamic DCI Indication On OCC Index
OCC method and OCC length are configured by RRC signaling. Dynamic switching between OCC and no OCC transmissions is not supported.
DCI format N0 is used to dynamic scheduling of NPUSCH transmissions with OCC index if OCC is configured.
For OCC length of 2, 1 bit is needed. Several methods are provided:
   Use the two most significant bits in the subcarrier indication field, 00 for OCC index 0, 11 for OCC index 1.
   Use the most significant bit in the subcarrier indication field, 0 for OCC index 0, 1 for OCC index 1.
   Reduce the entries in the table of number of repetitions to 4, and use the saved bit in the repetition number field for OCC index.
   Configure additional Radio Network Temporary Identifier (RNTI), e.g. OCC-RNTI. Using the current RNTI indicates OCC index 0, and new OCC-RNTI to indicate OCC index 1.
For OCC length of 4, 2 bits are needed. Several methods are provided:
   Use the two most significant bits in the subcarrier indication field, 00 for OCC index 0, 01 for OCC index 1, 10 for OCC index 2 and 11 for OCC index 3.
   Reduce the entries in the table of number of repetitions to 4, and use the saved bits in the repetition number field for OCC index.
   Configure a total of 4 RNTIs, e.g. 3 new OCC-RNTIs. Using the current RNTI to indicate OCC index 0, and new OCC-RNTI to indicate OCC index 1 to 3.
   Combination of RNTI, subcarrier indication field and repetition number field, e.g.:
      1 bit from additional RNTI, 1 bit from subcarrier indication field.
      1 bit from additional RNTI, 1 bit from repetition number field.
      1 bit from subcarrier indication field, 1 bit from repetition number field.

Additional or alternative RRC signaling with dynamic OCC on/off (similar to semi-persistent configuration with activation/deactivation):
RRC configure OCC and OCC length.
DCI indicate ON/OFF and OCC index.
   New RNTI for OCC on/off.
   Subcarrier indication field and/or repetition number field for OCC index.
      Dynamic Indication of OCC on/Off and/or OCC Length
Case 1: semi-static OCC on/off, dynamic OCC length indication.
   A total of 3 bits are needed for indication. The bits can be obtained by combinations of RNTI, subcarrier indication field and repetition number field.
   Configure additional RNTI, e.g. OCC-RNTI. Using the current RNTI indicates no OCC, and new OCC-RNTI to indicate OCC is applied.
   Depending on the OCC length, additional 1 or 2 bits can be used to indicate the OCC index.
      The bit(s) can be obtained by additional RNTI(s), or subcarrier indication field or repetition number field.
      The bit(s) can be obtained by the combination of additional RNTI(s) and/or subcarrier indication field and/or repetition number field.
Case 2: dynamic OCC on/off and OCC length indication.
   Alt 1: joint indication of parameters OCC on/off, OCC length, and OCC index.
      A table of 7 entries includes all combinations, 3 bits are needed for indication.
      The bits can be obtained by combinations of RNTI, subcarrier indication field and repetition number field.
   Alt 2: separate bits for dynamic OCC configuration and OCC index.
      Configure two additional RNTIs for OCC, e.g. OCC-RNTI1 and OCC-RNTI2. The selection of RNTI determines whether OCC is applied, and the OCC length if applied.
         If the existing RNTI is used in the DCI, no OCC is applied.
         If OCC-RNTI1 is used in the DCI, OCC length 2 is applied.
         If OCC-RNTI2 is used in the DCI, OCC length 2 is applied.
      Depending on the OCC length, additional 1 or 2 bits can be used to indicate the OCC index.
         The bit(s) can be obtained by additional RNTI(s), or subcarrier indication field or repetition number field.
         The bit(s) can be obtained by the combination of additional RNTI(s) and/or subcarrier indication field and/or repetition number field.

### IoT-NTN NPUSCH Enhancement

IoT-NTN has been specified and referenced in standards. Based on real deployment or deployment plans, further evolution of IoT-NTN is needed.

Need for Uplink capacity enhancement: NB-IoT NTN being deployed. In these early and upcoming deployments, it is clearly emerging that IoT-NTN, in particular NB-IoT, will have to support massive capacity in terms of number and types of UE, some of which with worse characteristics than others (e.g. low cost devices, wearables, etc). Multiplexing of UEs by usage of orthogonal cover codes (OCC) for NPUSCH format 1 and Narrowband Physical Random Access Channel (NPRACH) should therefore be studied, and if beneficial, be specified. Therefore, in order to unlock the additional UL capacity potential, there is a need to identify methods to de-couple the Uplink (UL) from the Downlink (DL) as much as possible.

For the support of capacity enhancements for uplink, the aim is to study then specify, if beneficial, enhancements to enable multiplexing of multiple UEs (e.g. up to the minimum of 4 and the maximum allowed by the existing UL and DL signaling) in a single 3.75 kHz or 15 kHz subcarrier via orthogonal cover codes (OCC) for NPUSCH format 1 and NPRACH.

The Rel-17 guard period locations and length for NB-IoT 3.75 kHz UL slot are preserved when OCC is applied to NPUSCH format 1. NPUSCH uses a slot based structure with resource unit allocations. Several OCC multiplexing methods for NPUSCH, including intra-symbol (pre-DFT) OCC, inter-symbol OCC, inter-slot OCC and inter-repetition or inter redundancy version (RV) OCC.

For OCC, single tone NPUSCH is prioritized more than multi-tone NPUSCH. For 3.75 kHz single-tone OCC for NPUSCH format 1, RANi supports either symbol-level OCC or slot-level OCC. Other OCC schemes are not pursued. For 15 kHz single-tone OCC for NPUSCH format 1, RANi supports either symbol-level OCC or slot-level OCC. Other OCC schemes are not pursued.

Therefore, only one OCC method may be defined for each scenario. In one case, symbol level OCC for 3.75 kHz and slot level OCC for 15 kHz. In another case, only one OCC method is specified for both 3.75 kHz and 15 kHz SCS, e.g. symbol level OCC or slot level OCC.

For both symbol-level OCC and slot-level OCC, further enhancements on the NPUSCH DMRS are needed. For the time-domain DMRS pattern (including blanked DMRS, if any), for 15 kHz single-tone, the Rel-17 DMRS pattern should be reused. And for 3.75 kHz single-tone, both Rel-17 DMRS pattern and a new DMRS pattern may be considered, provided that the DMRS overhead (including blanked DMRS, if any) for OCC is the same as for Rel-17.

The OCC is supported only for NPUSCH format 1, which is for FDD. NPUSCH format 2 is for TDD, and OCC will not be applied.

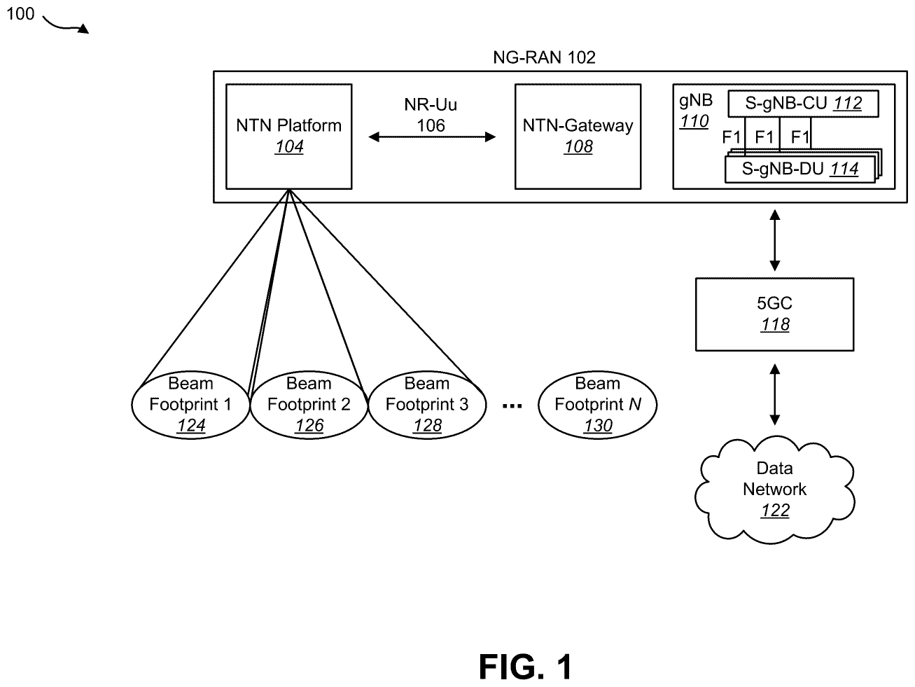

FIG. 1 is a diagram 100 illustrating an example 100 of a non-terrestrial network (NTN) coverage area with a plurality of beams. The Next Generation Radio Access Network (NG-RAN) 102 includes an NTN-Platform 104 in communication with an NTN-Gateway 108 through a 5G air interface, such an NR-Uu 106 (New Radio User Equipment (UE) to the NR Node B (gNB) radio interface). The NG-RAN 102 also includes a base station device (gNB) 110. The gNB 110 includes an S-gNB-CU (Secondary gNodeB Control Unit) 112 and an S-gNB-DU (Secondary gNodeB Distributed Unit) 114 in communication with each unit via F1 interfaces.

The NTN coverage area includes a plurality of beams having footprints: beam footprints 1, 2, 3, . . . N (124, 126, 128, 130). The 5G Core network (5GC) 118 is in communication with the NG-RAN 102 and a data network 122, such as a global communications network or other data network.

### DCI Format NO for IoT NPUSCH Scheduling

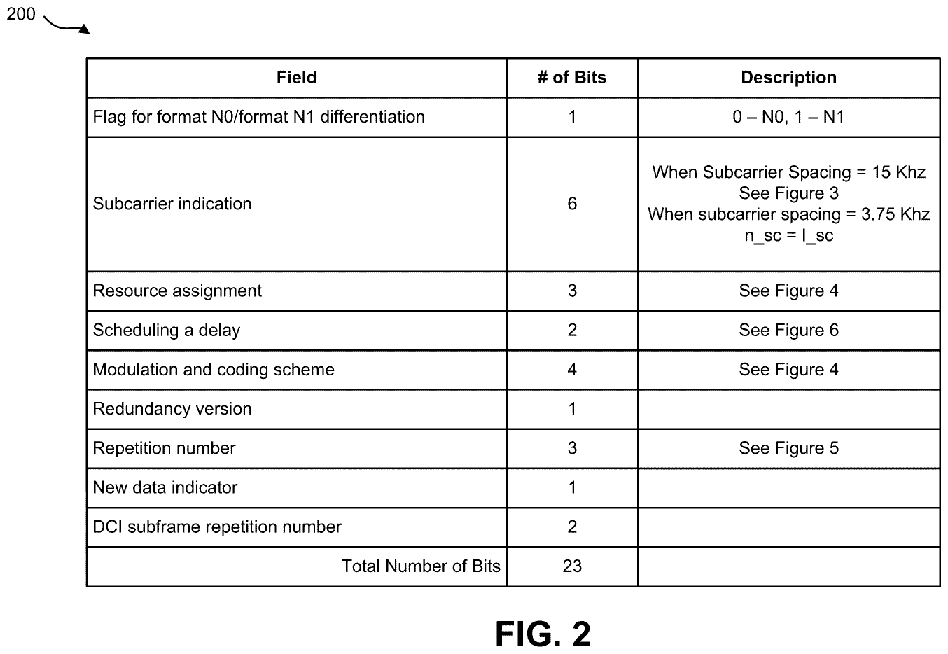

FIG. 2 is a table 200 illustrating an example of DCI format N0. DCI Format NO is for UL Grant, i.e. NPUSCH scheduling. Each of the fields in DCI format N0 are defined and summarized in the table shown in FIG. 2. In New Radio Physical Uplink Shared Channel (NR PUSCH), where the repetition number is semi-statically configured and not a part of the DCI. For IoT NPUSCH scheduling, all parameters are dynamically indicated in the DCI, including subcarrier indication, resource assignment, scheduling delay, Modulation and Coding Scheme (MCS) and repetition number, etc.

### Downlink Control Information

A DCI transports downlink or uplink scheduling information for one cell and one RNTI. The RNTI is implicitly encoded in the Cyclic Redundancy Check (CRC).

### DCI Format N0

DCI format N0 is used for the scheduling of NPUSCH and operation on preconfigured UL resources in one UL cell.

The following information is transmitted by means of the DCI format N0:
Flag for format N0/format N1 differentiation—1 bit, where value 0 indicates format N0 and value 1 indicates format N1.
Modulation and coding scheme—4 bits. This field is only present if format N0 CRC is scrambled by Paging User Radio Network Temporary Identifier (PUR-RNTI).

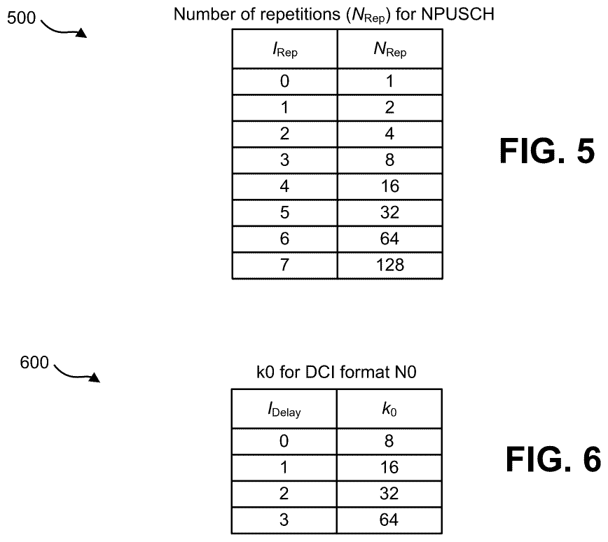

If format N0 CRC is scrambled by PUR-RNTI and Modulation and coding scheme is set to ‘1110’, the remaining fields are set as follows:
ACK or Fallback indicator—1 bit, where value 0 indicates ACK and value 1 indicates fallback.
NPUSCH repetition adjustment—3 bits refer to I_{Rep} in FIG. 5.
Timing advance adjustment—6 bits. The field is only present if ACK or Fallback indicator is set to 0.
All the remaining bits in format N0 are set to one.

Otherwise:
Subcarrier indication—6 bits.
Resource assignment—3 bits.
Scheduling delay—2 bits.
Modulation and coding scheme—4 bits. This field is not present if format N0 CRC is scrambled by PUR-RNTI. If npusch-16QAM-Config is configured and the value is ‘1111’, it functions as 16QAM indicator.
Redundancy version—1 bit.
Repetition number—3 bits. If 16QAM is indicated, it functions as Modulation and coding scheme for 16QAM.
New data indicator—1 bit. If multiple transport blocks (TB) are scheduled, it functions as New data indicator for the first TB.
DCI subframe repetition number—2 bits.
Number of scheduled TB for Unicast—1 bit, where value 0 indicates a single TB is scheduled and value 1 indicates multiple TB are scheduled. This field is only present if higher layer parameter npusch-MultiTB-Config is enabled and the corresponding DCI is mapped onto the UE specific search space given by the Cell Radio Network Temporary Identifier (C-RNTI). The field is set to 0 if the CRC of the DCI is scrambled by SPS C-RNTI.
Hybrid Automatic Repeat Request (HARQ) process number—1 bit. This field is only present if 2 HARQ processes are configured and the corresponding DCI format is mapped onto the UE specific search space given by the C-RNTI, or if the Number of scheduled TB for Unicast is present. If multiple TB are scheduled, it functions as New data indicator for the second TB.
Resource reservation—1 bit. This field is only present if higher layer parameter resourceReservationConfigUL is configured and the DCI is mapped onto the UE-specific search space given by C-RNTI.

If the number of information bits in format N0 mapped onto the UE specific search space given by the C-RNTI is less than that of format N1 in the same search space, zeros shall be appended to format N0 until the payload size equals that of format N1.

### Potential Spaces in DCI Format N0 for IoT NPUSCH Scheduling

To support OCC, at least the OCC index indication may be performed by the NPUSCH scheduling DCI with DCI format N0. Due to limited IoT capability, the DCI total number of bits, i.e. 23 bits in DCI format N0 should not be changed.

The RNTI for DCI, and the fields in the DCI format N0 can be evaluated on how to provide potential bits for OCC parameter indication, e.g. the OCC index and/or OCC length, etc.

### Subcarrier Indication Field

In DCI format N0, the subcarrier indication field has 6 bits, and not all bits are used in current standard.

For NPUSCH transmission with subcarrier spacing Δf=3.75 kHz, n_{sc}=I_{sc} where I_{sc} is the subcarrier indication field and I_{sc}=48, 49, . . . , 63 is reserved, or n_{sc} is configured by higher layers parameter npusch-SubCarrierSetIndex in PUR-Config-NB for NPUSCH transmissions using preconfigured uplink resources.

When Subcarrier Spacing=3.75 Khz, n_sc=I_sc, i.e. the subcarrier index is the same as the subcarrier indication index. Since only a single physical resource block (PRB) is supported, the index is from 0 to 11 within the resource block. Thus, only 4 bits are used in the subcarrier indication field, the two most significant bits are unused for the indication.

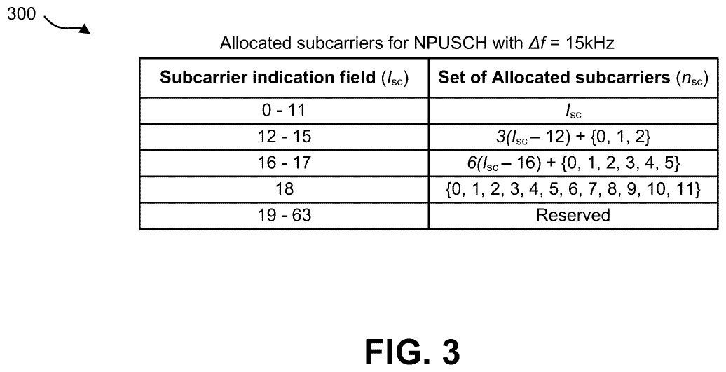

FIG. 3 is a table 300 illustrating an example of allocated subcarriers for NPUSCH with Δf=15 kHz. For NPUSCH transmission with subcarrier spacing Δf=15 kHz, the subcarrier indication field (I_{sc}) in the DCI or npusch-SubCarrierSetIndex in PUR-Config-NB for NPUSCH transmissions using preconfigured uplink resources determines the set of contiguously allocated subcarriers (n_{sc}) according to the table shown in FIG. 3.

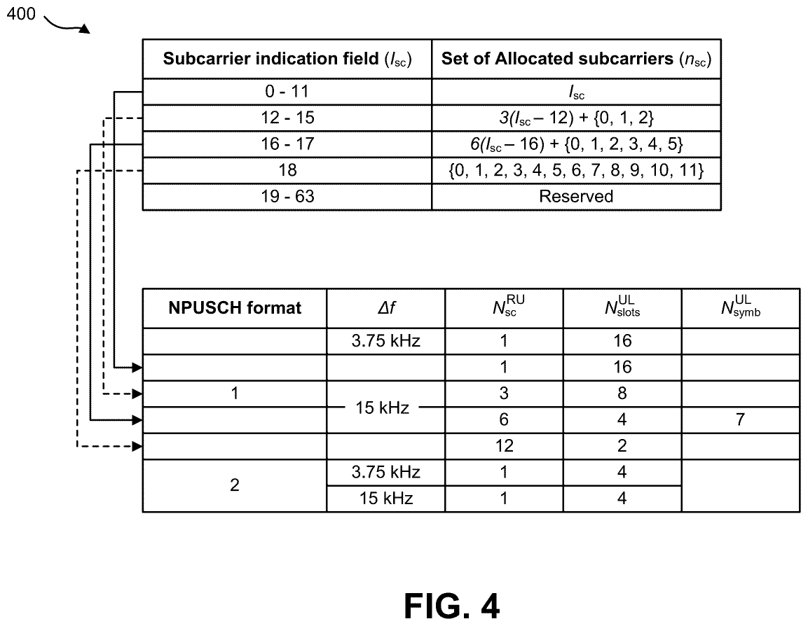

The tables 400 in FIG. 4 show how the subcarrier indication field in DCI format N0 specifies the specific subcarriers to allocate UL resources.

As shown in the Figures, for NPUSCH format 1 with a single subcarrier, i.e. single tone NPUSCH, only index 0-11 is used. Thus, only 4 bits are used in the subcarrier indication field, the two most significant bits are unused for the indication.

For NPUSCH with more than one subcarriers, i.e. multi-tone NPUSCH, up to 12 subcarriers can be used. The subcarrier indication field uses index 0-18. Thus, 5 bits are used, and the most significant bit is unused for the indication.

### The Repetition Number Field

FIG. 5 is a table 500 illustrating an example of the number of repetitions (N_{Rep}) for NPUSCH. The repetition number field has 3 bits, and the number of repetitions of each index is specified in the table shown in FIG. 5.

OCC itself is a kind of repetition with an OCC sequence. And the number of repetitions should be equal to or higher than the OCC multiplexing factor. The OCC multiplexing factor may also be known as OCC length, OCC capacity or OCC unit size. How to configure and interpret the N_Rep in the OCC case should be clarified.

In one alternative (Alt. 1), the N_Rep is the number of repetitions of a single NPUSCH transmission, same as NPUSCH repetition without OCC. Thus, in the time domain, each transmission in an OCC length is treated as a repetition. For example, a NPUSCH with OCC length of 4 consists of 4 repetitions in an OCC multiplexing window. Since the number of repetitions should be the same or higher than the OCC multiplexing factor, the valid entries can be reduced. For example, for OCC length of 2, the N_Rep of 1 is no long valid, and for OCC length of 4, the N_Rep of 1 and 2 are not valid.

In another alternative (Alt. 2), N_Rep refers to the number of repetitions for OCC unit transmissions. Each OCC unit is defined by the OCC multiplexing factor. Thus, the actual number of repetitions as a ratio of single NPUSCH transmission is the multiplication of the OCC length and the N_Rep. Thus, if the same parameters are maintained as no OCC case, the values for the N_Rep can be reduced by the OCC factor. For example, for OCC length of 2, the N_Rep of 128 may not be used, and for OCC length of 4, the N_Rep of 128 and 64 may not be applied.

In both cases, only 1 or 2 entries can be removed from the existing table. It is not sufficient to save even 1 bit of code space. Thus, additional modifications are needed to further reduce the candidate values in the table.

Considering NTN IoT devices, the coverage is much larger than transport network (TN) cases, and the link distance is very long compared with TN IoT devices. Also, the number of repetitions for communicating with satellites at different heights or orbits can be different. Thus, the number of repetitions required for an NTN IoT device could be larger, or even beyond the maximum repetitions in the current table.

Therefore, a new number of repetitions table may be defined for NTN IoT to represent the required repetitions for NTN IoT devices based on different satellite orbits. For example, the small entries like 1, 2, 4, etc. may not be needed for NTN IoT, and new values such as 256 and 512 may be added to the number of repetitions table.

Furthermore, the NTN link is somehow stable and predictable for a satellite at a given height, the number of repetitions does not need to be changed in so many different levels. Thus, it is possible to reduce the number of valid entries in the number of repetitions table for NTN IoT, and leave space for OCC index indication.

For example, if 4 entries are specified for the number of repetitions table for NTN IoT, only 2 bits are used for the number of repetitions, and the remaining 1 bit can be used for OCC index indication. And if 2 entries are specified for the number of repetitions table for NTN IoT, only 1 bit is used for the number of repetitions, and the remaining 2 bits can be used for OCC index indication. In another example, the number of repetitions for an NTN IoT device may be configured semi-statically by RRC signaling, and all 3 bits for the number of repetitions can be reused for OCC index indication.

The new number of repetitions table can be configured semi-statically by higher layer signaling. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

### Additional RNTI for DCI Format N0

A DCI transports downlink or uplink scheduling information for one cell and one RNTI. The RNTI is implicitly encoded in the CRC. To provide additional bits for the DCI, additional RNTIs, e.g. OCC-RNTI, can be configured. For example, if two RNTIs are configured for the scheduling DCI, 1 bit is implicitly indicated by selecting between the existing RNTI and the OCC-RNTI. Similarly if four RNTIs are configured for the scheduling DCI, 2 bits are implicitly indicated by selecting an RNTI from the set.

### Other Fields in the DCI

Other fields in the DCI format N0 may also be considered, e.g. the scheduling delay field and the DCI subframe repetition number field. As an example, the scheduling delay field has 2 bits with 4 possible values to indicate the delay parameter k0 as shown in the table of FIG. 6. FIG. 6 is a table 600 illustrating an example of the scheduling delay field and the DCI subframe repetition number field in DCI format.

For NTN, the satellite link has long distance, and the timing alignment requires a cell specific offset k_offset and autonomous Timing Advance (TA) compensation based on Global Navigation Satellite System (GNSS) location information of the UE. The k0 delay is applied additionally after k_offset and TA compensation is performed. Compare with TN, NTN scheduling delay k0 does not provide significant variations for the NTN devices. The delay provides some scheduling flexibility on the NPUSCH transmission timing as well as NTN device pairing when OCC is applied.

Therefore, in one case, the k0 value for NTN can be fixed, and the two bits in the scheduling delay field may be used for OCC index indication. In another case, only 2 values may be defined, and use the remaining 1 bit for OCC index indication. The scheduling delay can be fixed with a specified value, or the scheduling delay can be configured semi-statically by higher layer signaling. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

### NPUSCH OCC Signaling Methods

The detailed OCC multiplexing methods are out of scope of this disclosure. Regardless of the OCC method, some configuration and signaling for OCC should be supported and specified in the standard. Different levels of control may be specified.

At one level, whether OCC is applied or not on a NPUSCH, the OCC on/off may be configured semi-statically by higher layer signaling. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

The OCC on/off may be dynamically indicated. There may be some benefits with dynamic OCC on/off indication. For example, OCC is more complicated, and potential performance loss compared with no OCC case, and the eNB needs to find matching IoT devices for OCC multiplexing. Furthermore, the OCC scheduling requires aligned resource assignment and timing for IoT devices for OCC multiplexing. If there is no matching IoT devices, NPUSCH without OCC is simpler and more efficient.

If OCC is applied, the OCC multiplexing factor should also be signaled. The multiplexing factor is also known as unit length of OCC, OCC length, OCC capacity, etc. At least OCC multiplexing factors of 2 and 4 should be supported. The OCC multiplexing factor may be configured semi-statically by higher layer signaling. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

The OCC multiplexing factor may be dynamically indicated. The OCC structure is different for different multiplexing factors. Thus, devices with different OCC multiplexing factors cannot be scheduled on the same resources; and different OCC lengths cannot have the same OCC indexes either.

With a given OCC multiplexing factor, the OCC index, or the OCC sequence, should be signaled to a NTN-IoT device for NPUSCH transmission with OCC. The OCC index should be dynamically indicated to have flexible scheduling of NTN-IoT devices for appropriate OCC groups. The dynamic indication can be implemented by DCI format and/or C-RNTI for the scheduling DCI.

As a simple solution, all the parameters, i.e. the OCC method, OCC multiplexing factor and OCC index, may be semi-statically configured by higher layer signaling. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied. It is up to an eNB to find suitable IoT devices for OCC pairing with different OCC indexes. This method is simple, but lacks flexibility. Thus, it is not a good solution for NPUSCH OCC indication.

Based on the signaling flexibility, several methods with different levels of configuration and dynamic indication may be considered.

### Method 1: Semi-Static Configuration of OCC Method and OCC Multiplexing Factor, Dynamic Indication of OCC Index.

In this method, an IoT NTN device is configured with either NPUSCH with OCC or NPUSCH without OCC. Dynamic switching between OCC and non-OCC is not supported.

If OCC is configured by higher layer signaling, the OCC multiplexing factor or OCC length or OCC capacity should be further configured by higher layer signaling, i.e. RRC signaling. The OCC multiplexing factor may be configured as 2 or 4 at least. Higher multiplexing factor, e.g. 8, may be supported. In this method, the OCC length cannot be dynamically changed either. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

With configured OCC multiplexing factor or OCC length, the OCC index may be dynamically indicated by the eNB to the NTN-IoT device in the scheduling DCI. If OCC multiplexing factor of 2 is configured, 1 bit is needed to indicate the OCC index 0 or 1. If OCC multiplexing factor of 4 is configured, 2 bits are needed to indicate the OCC index.

The indication can be performed by the NPUSCH scheduling DCI, i.e. DCI format N0. Due to limited IoT capability, the DCI total number of bits, i.e. 23 bits in DCI format N0 should not be changed. Therefore, some approaches may be defined to provide the required 1 or 2 bits for DCI format N0, as discussed in detail below.

For OCC length of 2, only 1 bit is needed to indicate the OCC index 0 or 1.

### Approach 1: Re-Interpret Unused Bits in the Subcarrier Indication Field

As discussed above, out of the 6 bits for subcarrier indication field, only 4 bits are used for NPUSCH with 3.75 kHZ SCS and single tone NPUSCH with 15 kHZ SCS. And 5 bits are used for multi-tone NPUSCH with 15 kHZ SCS. The unused bit(s) may be assigned to indicate the OCC index. To support OCC length of 2, several options can be considered.

Option 1: the two most significant bits in the subcarrier indication field are used to indicate OCC index

For OCC index 0, 00 is used in the two most significant bits in the subcarrier indication field. And 11 is used in the two most significant bits in the subcarrier indication field to indicate OCC index 1. Option 1 can be applied for 3.75 kHz SCS. Option 1 can be used for 15 kHz SCS if only single tone NPUSCH is specified for OCC support.

Option 2: only the most significant bit in the subcarrier indication field is used to indicate OCC index

For OCC index 0, 0 is used in the most significant bit in the subcarrier indication field. And 1 is used in the most significant bit in the subcarrier indication field to indicate OCC index 1. Option 2 can be applied for 3.75 kHz SCS and 15 kHz SCS even if multi-tone NPUSCH is supported for OCC.

Option 3: different bits are used for 3.75 kHz SCS and 15 kHz SCS

In this option, the two most significant bits in the subcarrier indication field are used to indicate OCC index for 3.75 kHz SCS, as in Option 1; and only the most significant bit in the subcarrier indication field is used to indicate OCC index for 15 kHz SCS.

Approach 2: Save Space from Repetition Number Field

In another approach, the repetition number field can be compressed to save space for OCC index indication. For OCC length of 2, the number of repetitions table may be configured with only 4 entries for NTN IoT. Thus, only the lower 2 bits are used for the number of repetitions for indexes 0-3. The remaining 1 bit, e.g. the most significant bit, can be used for OCC index indication. For OCC index 0, 0 is used in the most significant bit in the repetition number field. And 1 is used in the most significant bit in the repetition number field to indicate OCC index 1.

Other DCI fields may be considered, e.g. reduce the number of entries in the scheduling delay field, and use the saved bit for OCC index indication.

### Approach 3: Introduce New RNTI for OCC NPUSCH Scheduling

Yet in another approach, additional RNTI can be configured for DCI. To provide OCC index with OCC length of 2, an additional new RNTI can be configured. If the current RNTI is used for the CRC masking, an OCC index 0 is indicated. And if the new additional RNTI is used for the CRC masking, an OCC index 1 is indicated.

For OCC length of 4, 2 bits are needed to indicate the OCC index from 0 to 3 (e.g. 00, 01, 10, 11), i.e. the OCC sequence to be applied based on the OCC index. Similarly, different approaches can be used for OCC length of 4.

### Approach 1: Re-Interpret Unused Bits in the Subcarrier Indication Field

The two most significant bits in the subcarrier indication field are used to indicate OCC index. The OCC index is represented by the two most significant bits in the subcarrier indication field with combinations of 00, 01, 10, 11 for OCC index 0, 1, 2, 3 respectively.

This can be applied for 3.75 kHz SCS. Option 1 can be used for 15 kHz SCS if only single tone NPUSCH is specified for OCC support. Since single tone NPUSCH is prioritized for OCC, this may be sufficient.

Approach 2: Save Space from Repetition Number Field

In another approach, the repetition number field can be compressed to save space for OCC index indication. For OCC length of 4, the number of repetitions table may be configured with only 2 entries for NTN IoT. Thus, only the lowest bits is used for the number of repetitions for indexes 0-1. The remaining 2 most significant bits, can be used for OCC index indication. The OCC index is represented by the two most significant bits in the repetition number field with combinations of 00, 01, 10, 11 for OCC index 0, 1, 2, 3 respectively.

Other DCI fields may be considered, e.g. fix the scheduling delay or configure the delay by higher layer signaling, and use two bits for OCC index indication.

### Approach 3: Introduce New RNTIs for OCC NPUSCH Scheduling

Yet in another approach, additional RNTIs can be configured for DCI. To provide OCC index with OCC length of 2, three additional new RNTIs can be configured, e.g. with a RNTI table. The index of the configured RNTI can be used to implicitly indicate the OCC index. For example, if the current RNTI is used for the CRC masking, an OCC index 00 is indicated. And if an additional RNTI is used for the CRC masking, an RNTI index determines the OCC index.

### Approach 4: Combinations of Different Approaches

In Approach 1, if multi-tone NPUSCH is also supported, there will be ambiguity on the indexes 16-18. In Approach 2, since the number of entries in the number of repetition field is reduced, the scheduling flexibility is also reduced. In Approach 3, it may introduce too much overhead on the RNTI configurations and the number of blind decoding at the NTN IoT devices.

Therefore, some combinations of the approaches may be used instead to reduce the impact from single approach. As long as 2 bits can be provided, the OCC index can be indicated dynamically.

Case 1: 1 bit from the subcarrier indication field, and 1 bit from the repetition number field.

In this case, only the most significant bit in the subcarrier indication field is used to indicate OCC index. This avoids potential conflict when multi-tone NPUSCH is supported. And the number of repetitions table may be configured with 4 entries for NTN IoT. Thus, the most significant bit in the subcarrier indication field can be used for OCC index indication.

Case 2: 1 bit from the subcarrier indication field, and 1 bit from additional RNTI

In this case, only the most significant bit in the subcarrier indication field is used to indicate OCC index. And one additional RNTI may be configured to provide the other bit for OCC index indication.

Case 3: 1 bit from the repetition number field, and 1 bit from additional RNTI

In this case, the number of repetitions table may be configured with 4 entries for NTN IoT. Thus, the most significant bit in the subcarrier indication field can be used for OCC index indication. Also, one additional RNTI may be configured to provide the other bit for OCC index indication.

In all cases, the order of the bits should be specified in the standard with OCC index mapping for the indication.

Approach 5: Semi-Static Configuration with Dynamic OCC on/Off Indication

Alternatively or additionally, the OCC method and OCC multiplexing factor can be semi-statically configured, but whether OCC is applied is dynamically indicated by the DCI. If OCC is applied, OCC index is also dynamically indicated by the DCI. This is similar to semi-persistent configurations, the OCC on/off is similar to an activation/deactivation process for a semi-persistent configuration.

Alternatively, a MAC CE may be used to activate/deactivate the OCC method. However, a MAC CE activation and deactivation is still semi-static for the OCC method. And MAC CE cannot dynamically schedule a NPUSCH transmission and cannot indicate the OCC index dynamically.

A new RNTI, e.g. OCC-RNTI can be introduced for NPUSCH scheduling. If the existing RNTI is used in the DCI, no OCC is applied. If the new OCC-RNTI1 is used in the DCI, OCC is applied. If OCC in applied, the OCC index is indicated in the DCI fields.

The OCC multiplexing factor or OCC length is semi-statically configured, and 1 bit is required to indicate the OCC index with OCC length of 2, and 2 bits are required to indicate the OCC index with OCC length of 4.

For 1 bit of OCC index with OCC length of 2, the OCC index may be indicated by the unused bit in subcarrier indication field or saved bit in the repetition number field, as discussed above in Approach 1 and Approach 2 for OCC length of 2.

For 2 bits of OCC index with OCC length of 4, the OCC index may be indicated by the unused bit in subcarrier indication field or saved bit in the repetition number field, as discussed above in Approach 1 and Approach 2 for OCC length of 4, or a combination of 1 bit from the subcarrier indication field, and 1 bit from the repetition number field.

### Method 2: Semi-Static Configuration of OCC Method, Dynamic Indication Of OCC Multiplexing Factor and OCC Index.

In this method, an IoT NTN device is configured with either NPUSCH with OCC or NPUSCH without OCC by higher layer signaling. Dynamic switching between OCC and non-OCC is not supported. The higher layer signaling can be a RRC configuration. The higher layer signaling can be a combination of RRC configuration and MAC CE. For example, one or more configurations are included in a RRC signaling, and a MAC CE is used to indicate which parameter or set of parameters are applied.

To provide better scheduling flexibility, the OCC length or OCC multiplexing factor may be dynamically indicated. Since IoT devices with different OCC lengths cannot be multiplexed on the same resources, the dynamic indication of OCC length allows the eNB to schedule OCC pairs more effectively and efficiently.

With this method, 1 bit is needed to indicate the multiplexing factor between 2 and 4, e.g. a bit of 0 for OCC length of 2, and a bit 1 for OCC length of 4. It is better to have a separate bit for the OCC length indication instead of mixing the OCC length with OCC index. For example, one additional RNTI may be configured to provide 1 bit for the selection between OCC length 2 and 4. If the existing RNTI is used, OCC length 2 is indicated. If the new additional RNTI is used, OCC length 4 is indicated.

For the OCC length indication method, one of the potential bit spaces mentioned above can be used. For example, 1 bit from additional RNTI, or 1 bit from the subcarrier indication field, or 1 bit from the repetition number field.

For OCC length of 2, one additional bit is needed to indicate the OCC index. Thus, a total of 2 bits are needed. For two bits, the approaches for Method 1 with OCC length of 4 can be used with different interpretations. For example,
Case 1: 1 bit from additional RNTI to indicate OCC length 2 or 4, 1 bit from subcarrier indication field to indicate the OCC index. Or vice versa.
Case 2: 1 bit from additional RNTI to indicate OCC length 2 or 4, 1 bit from the repetition number field to indicate the OCC index. Or vice versa.
Case 3: 1 bit from subcarrier indication field to indicate OCC length 2 or 4, 1 bit from the repetition number field to indicate the OCC index. Or vice versa. Thus, no additional RNTI is needed.

For OCC length of 4, two additional bits are needed to indicate the OCC index. Thus, a total of 3 bits are needed. Some combinations of the potential bit spaces can be applied with new interpretation. For example:
Example 1: 1 bit from additional RNTI to indicate OCC length 2 or 4, 2 bits from subcarrier indication field to indicate the OCC index.
Example 2: 1 bit from additional RNTI to indicate OCC length 2 or 4, combine 1 bit from subcarrier indication field and 1 bit from the repetition number field to indicate the OCC index.

Other bit combinations from different potential spaces may also be derived. In all cases, once the information bit spaces are assigned, the order of the bits should be specified in the standard with OCC length and OCC index mapping for the indication.

### Method 3: Dynamic Indication of OCC Method, OCC Multiplexing Factor And OCC Index.

To provide maximum scheduling flexibility, all parameters can be scheduled by the DCI. Thus, at least 1 bit for OCC on/off, 1 bit for OCC length or OCC multiplexing factor, and 1 or 2 bits for the OCC index.

### Alternative 1: Define a Mapping Table for Different OCC Combination and Indicate the Index in the Table

Including no OCC case, OCC with length 2 and 4, there are a total of 7 possible combinations, i.e.:
no OCC
OCC 2× with OCC index 0
OCC 2× with OCC index 1
OCC 4× with OCC index 0
OCC 4× with OCC index 1
OCC 4× with OCC index 2
OCC 4× with OCC index 3

Therefore, a total of 3 bits is sufficient to indicate all the parameters. Some combinations of the potential bit spaces can be applied with new interpretation. For example:
1 bit from additional RNTI, 2 bits from the subcarrier indication field.
1 bit from additional RNTI, 1 bit from the subcarrier indication field and 1 bit from the repetition number field.
2 bits from the subcarrier indication field and 1 bit from the repetition number field. In this case, no additional OCC-RNTI is needed.

Other bit combinations from different potential spaces may also be derived. In all cases, once the information bit spaces are assigned, the order of the bits should be specified in the standard with OCC length and OCC index mapping for the indication.

Alternative 2: Separate Bits for OCC on/Off, OCC Length and OCC Index

In another alternative, some bits may be used for OCC on/off and OCC length parameter. And separate bits are allocated for OCC index if OCC is indicated.

In one implementation, two additional RNTIs for OCC, e.g. OCC-RNTI1 and OCC-RNTI2, can be configured to represent OCC length 2 and OCC length 4 respectively. The selection of RNTI determines whether OCC is applied, and the OCC length if applied. If the existing RNTI is used in the DCI, no OCC is applied. If OCC-RNTI1 is used in the DCI, OCC length 2 is applied. If OCC-RNTI2 is used in the DCI, OCC length 4 is applied. If OCC is indicated, additional 1 or 2 bits can be used to indicate the OCC index.

For OCC length of 2, 1 bit information may be provided by the subcarrier indication field or the repetition number field as described above. For OCC length of 4, 2 bits of information may be provided by the subcarrier indication field and/or the repetition number field. For example, 2 bits from the subcarrier indication field only, or 2 bits the repetition number field only, or 1 bit from the subcarrier indication field and 1 bit from the repetition number field.

With 1 bit used for OCC on/off, 1 bit for selection of OCC length 2 and 4, and 1 or 2 bits for OCC index, up to 4 bits may be needed. Some combinations of the potential bit spaces can be applied with new interpretation. Some combinations of the potential bit spaces can be applied with new interpretation. For example, 1 bit for OCC on/off by adding a OCC RNTI, 2 bits from subcarrier indication field, and 1 bit from the repetition number field.

In all cases, once the information bit spaces are assigned, the order of the bits should be specified in the standard with OCC length and OCC index mapping for the indication.

Special handling for Msg 3 NPUSCH

OCC support of NPUSCH may be configured by a higher layer. OCC support may be dynamically indicated to a UE by the scheduling DCI. However, some special handling may be need for Msg3 NPUSCH scheduling and transmissions.

Since Msg 3 is contention based, eNB does not know which UE is transmitting. Thus, it is not appropriate to include an OCC index. Even if OCC index is indicated, multiple UEs would use the same OCC index and cause a collision.

Therefore, for Msg3 NPUSCH scheduling, OCC may not be supported and no DCI field re-interpretation should be applied. Even in case of RRC connected mode and OCC configuration, OCC is not applicable to Msg 3 scheduling, i.e. a fallback mode operation may be used for Msg 3 NPUSCH.

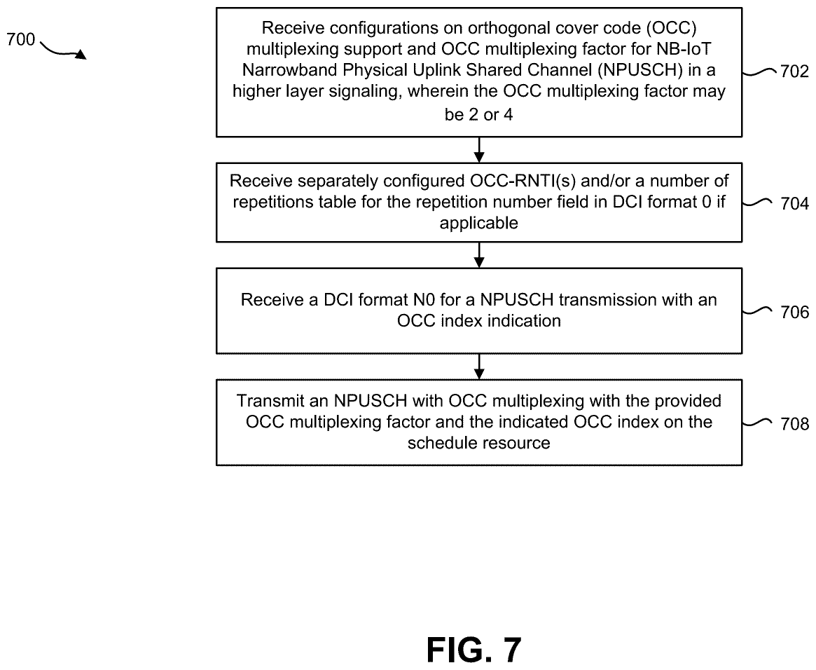

FIG. 7 is a flow diagram illustrating a method 700 by a UE. The UE may be an internet of things (IoT) non-terrestrial network (NTN) device user equipment (UE). The UE may receive 702 configurations on orthogonal cover code (OCC) multiplexing support and OCC multiplexing factor for NB-IoT Narrowband Physical Uplink Shared Channel (NPUSCH) in a higher layer signaling. The OCC multiplexing factor may be 2 or 4. The UE may receive 704 separately configured OCC-RNTI(s) and/or a number of repetitions table for the repetition number field in DCI format 0, if applicable. The UE may receive 706 a DCI format N0 for a NPUSCH transmission with an OCC index indication. The UE may transmit 708 an NPUSCH with OCC multiplexing with the provided OCC multiplexing factor and the indicated OCC index on the schedule resource.

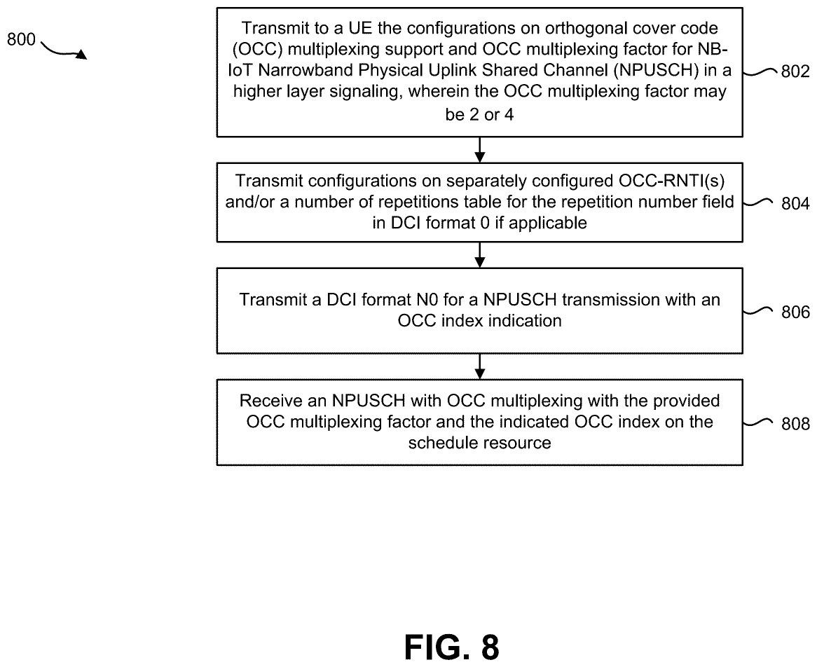

FIG. 8 is a flow diagram illustrating a method 800 by an eNB. The eNB may transmit 802 to a UE the configurations on orthogonal cover code (OCC) multiplexing support and OCC multiplexing factor for NB-IoT Narrowband Physical Uplink Shared Channel (NPUSCH) in a higher layer signaling, wherein the OCC multiplexing factor may be 2 or 4. The eNB may transmit 804 configurations on separately configured OCC-RNTI(s) and/or a number of repetitions table for the repetition number field in DCI format 0 if applicable. The eNB may transmit 806 a DCI format N0 for a NPUSCH transmission with an OCC index indication. The eNB may receive 808 an NPUSCH with OCC multiplexing with the provided OCC multiplexing factor and the indicated OCC index on the schedule resource.

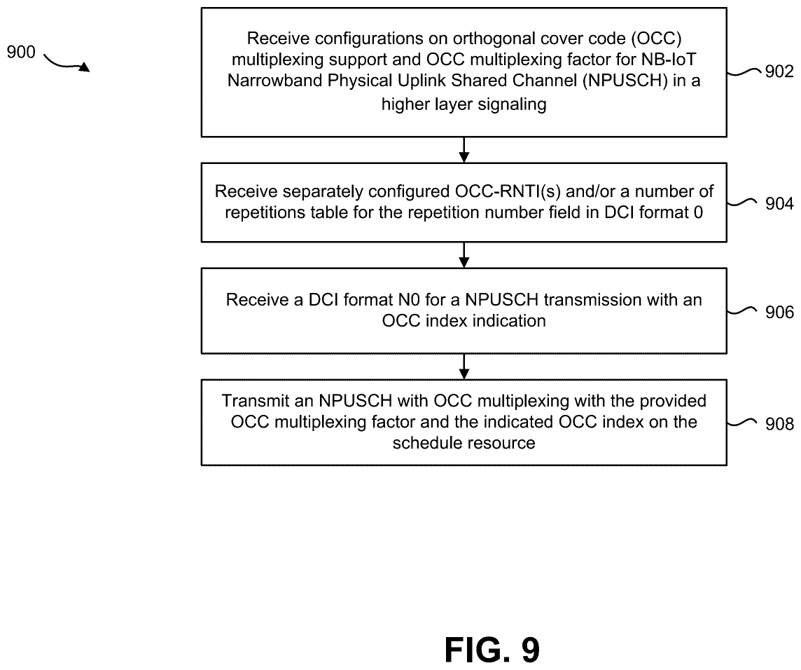

FIG. 9 is a flow diagram illustrating an example of another method 900 by a UE. The UE may receive 902 configurations on orthogonal cover code (OCC) multiplexing support and OCC multiplexing factor for NB-IoT Narrowband Physical Uplink Shared Channel (NPUSCH) in a higher layer signaling. The UE may receive 904 separately configured OCC-RNTI(s) and/or a number of repetitions table for the repetition number field in DCI format 0. The UE may receive 906 a DCI format N0 for a NPUSCH transmission with an OCC index indication. The UE may transmit 908 an NPUSCH with OCC multiplexing with the provided OCC multiplexing factor and the indicated OCC index on the schedule resource.

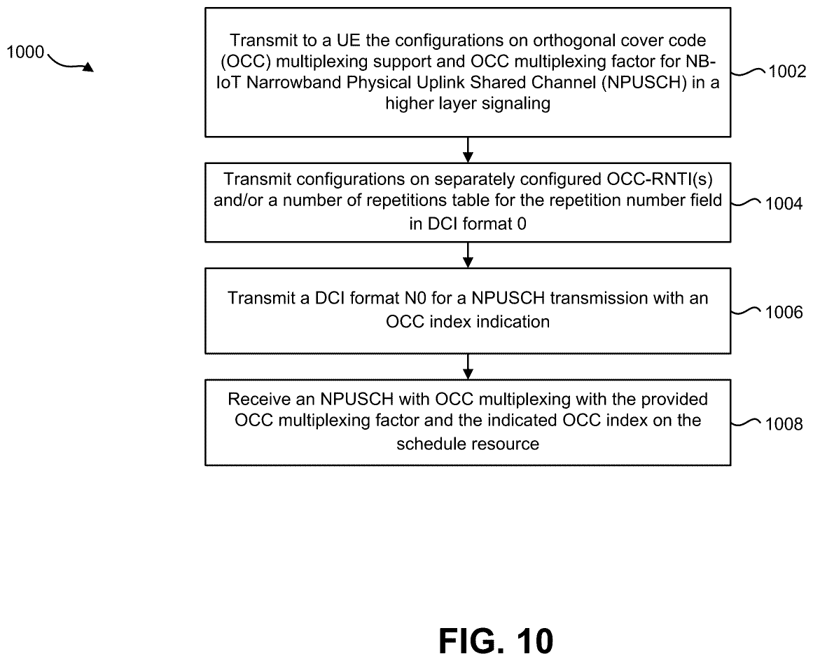

FIG. 10 is a flow diagram illustrating an example of another a method 1000 by an eNB. The eNB may transmit 1002 to a UE the configurations on orthogonal cover code (OCC) multiplexing support and OCC multiplexing factor for NB-IoT Narrowband Physical Uplink Shared Channel (NPUSCH) in a higher layer signaling. The eNB may transmit 1004 configurations on separately configured OCC-RNTI(s) and/or a number of repetitions table for the repetition number field in DCI format 0. The eNB may transmit 1006 a DCI format N0 for a NPUSCH transmission with an OCC index indication. The eNB may receive 1008 an NPUSCH with OCC multiplexing with the provided OCC multiplexing factor and the indicated OCC index on the schedule resource.

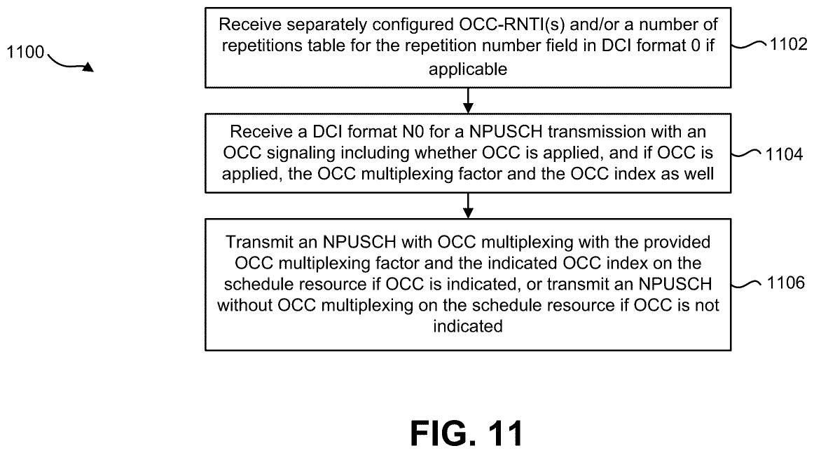

FIG. 11 is a flow diagram illustrating a yet further example of another a method 1100 by a UE. The UE may receive 1102 separately configured OCC-RNTI(s) and/or a number of repetitions table for the repetition number field in DCI format 0 if applicable. The UE may receive 1104 a DCI format N0 for a NPUSCH transmission with an OCC signaling including whether OCC is applied, and if OCC is applied, the OCC multiplexing factor and the OCC index as well. The UE may transmit 1106 an NPUSCH with OCC multiplexing with the provided OCC multiplexing factor and the indicated OCC index on the schedule resource if OCC is indicated, or transmit an NPUSCH without OCC multiplexing on the schedule resource if OCC is not indicated.

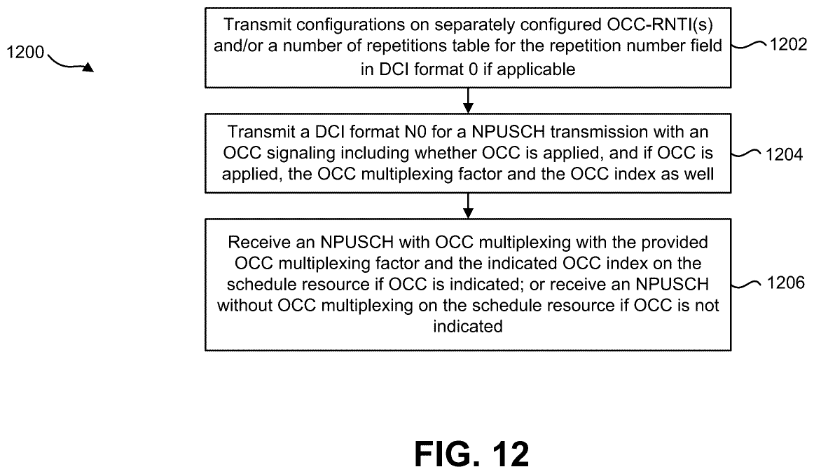

FIG. 12 is a flow diagram illustrating a yet further example of another a method 1200 by an eNB. The eNB may transmit 1202 configurations on separately configured OCC-RNTI(s) and/or a number of repetitions table for the repetition number field in DCI format 0 if applicable. The eNB may transmit 1204 a DCI format N0 for a NPUSCH transmission with an OCC signaling including whether OCC is applied, and if OCC is applied, the OCC multiplexing factor and the OCC index as well. The eNB may receive 1206 an NPUSCH with OCC multiplexing with the provided OCC multiplexing factor and the indicated OCC index on the schedule resource if OCC is indicated; or receive an NPUSCH without OCC multiplexing on the schedule resource if OCC is not indicated.

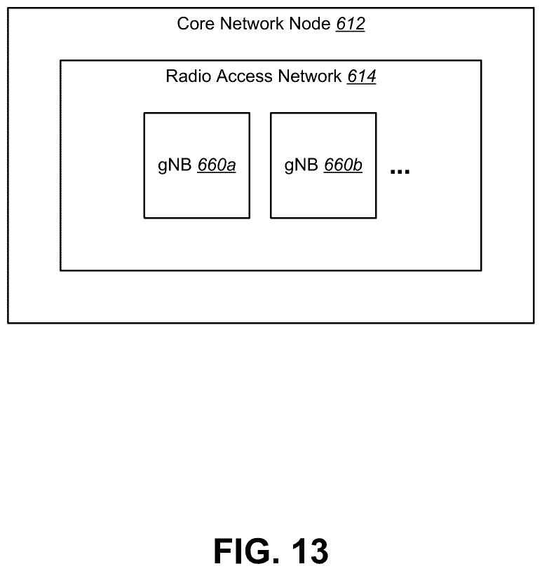

FIG. 13 is block diagram illustrating one implementation of a core network node 612. The core network node 612 may include a radio access network 614 that includes a plurality of gNBs (gNB 660a, 660b). Messages transmitted and received by the core network node 612 may be transmitted and received by the gNBs 660a, 660b in the radio access network 614. The core network node 612 may be part of the 5GC 118 or the NG-RAN 102.

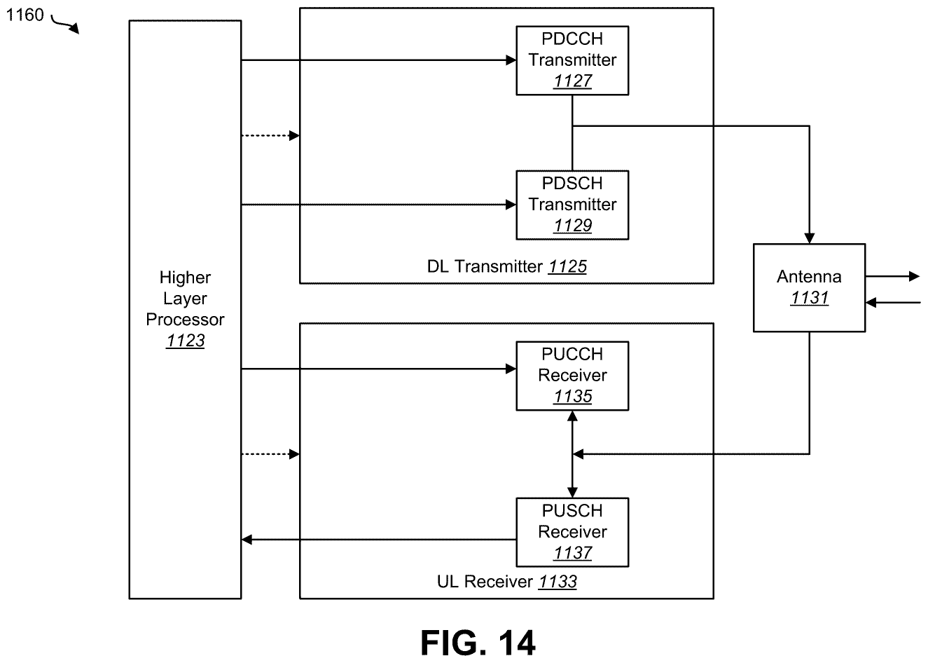

FIG. 14 is a block diagram illustrating one implementation of a eNB 1160. The eNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send and/or acquire higher layer messages such as an RRC message and MAC message to and/or from a wireless terminal's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 Uplink Control Information (UCI). The PUSCH receiver 1137 may provide the higher layer processor 1123 received transport blocks.

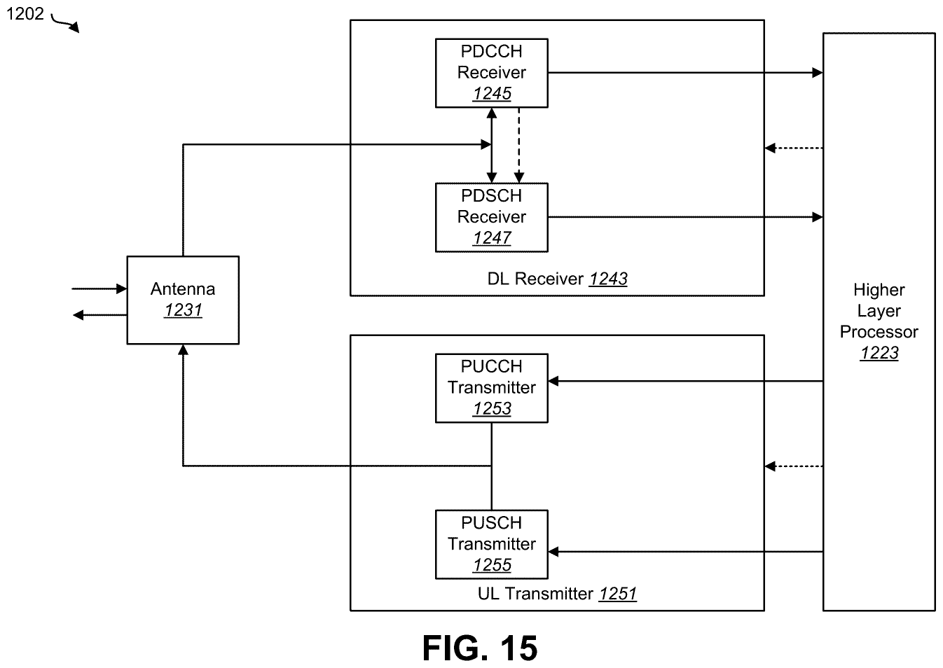

FIG. 15 is a block diagram illustrating one implementation of a wireless terminal 1202. In some examples, the wireless terminal 1202 is a UE. The wireless terminal 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send and/or acquire higher layer messages such as an RRC message and MAC message to and/or from a wireless terminal's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI (Downlink Control Information). The PDSCH receiver 1247 may provide the higher layer processor 1223 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

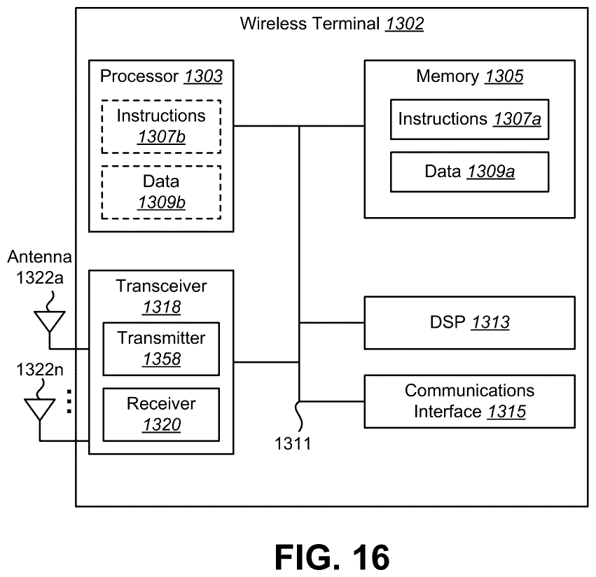

FIG. 16 illustrates various components that may be utilized in a wireless terminal 1302. In some examples, the wireless terminal 1302 is a UE. The wireless terminal 1302 described in connection with FIG. 16 may be implemented in accordance with the wireless terminal described herein. The wireless terminal 1302 includes a processor 1303 that controls operation of the wireless terminal 1302. The processor 1303 may also be referred to as a central processing unit (CPU). Memory 1305, which may include read-only memory (ROM), random access memory (RAM), a combination of the two or any type of device that may store information, provides instructions 1307a and data 1309a to the processor 1303. A portion of the memory 1305 may also include non-volatile random-access memory (NVRAM). Instructions 1307b and data 1309b may also reside in the processor 1303. Instructions 1307b and/or data 1309b loaded into the processor 1303 may also include instructions 1307a and/or data 1309a from memory 1305 that were loaded for execution or processing by the processor 1303. The instructions 1307b may be executed by the processor 1303 to implement the methods described above.

The wireless terminal 1302 may also include a housing that contains one or more transmitters 1358 and one or more receivers 1320 to allow transmission and reception of data. The transmitter(s) 1358 and receiver(s) 1320 may be combined into one or more transceivers 1318. One or more antennas 1322a-n are attached to the housing and electrically coupled to the transceiver 1318.

The various components of the wireless terminal 1302 are coupled together by a bus system 1311, which may include a power bus, a control signal bus and a status signal bus, in addition to a data bus. However, for the sake of clarity, the various buses are illustrated in FIG. 16 as the bus system 1311. The wireless terminal 1302 may also include a digital signal processor (DSP) 1313 for use in processing signals. The wireless terminal 1302 may also include a communications interface 1315 that provides user access to the functions of the wireless terminal 1302. The wireless terminal 1302 illustrated in FIG. 24 is a functional block diagram rather than a listing of specific components.

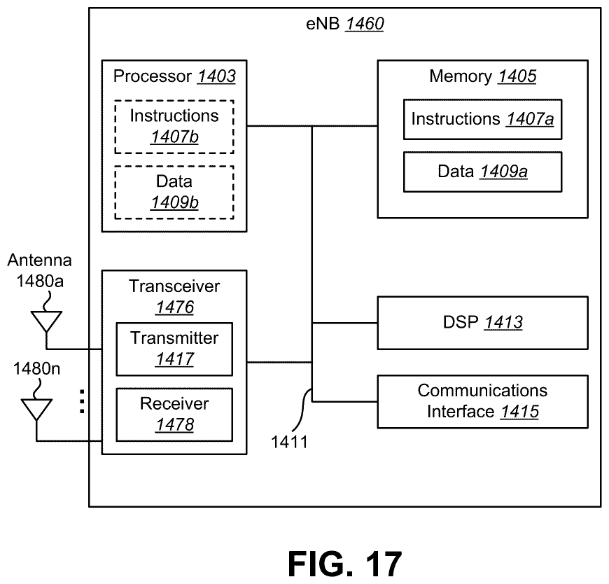

FIG. 17 illustrates various components that may be utilized in a eNB 1460. The eNB 1460 described in connection with FIG. 16 may be implemented in accordance with the eNB described herein. The eNB 1460 includes a processor 1403 that controls operation of the eNB 1460. The processor 1403 may also be referred to as a central processing unit (CPU). Memory 1405, which may include read-only memory (ROM), random access memory (RAM), a combination of the two or any type of device that may store information, provides instructions 1407a and data 1409a to the processor 1403. A portion of the memory 1405 may also include non-volatile random-access memory (NVRAM). Instructions 1407b and data 1409b may also reside in the processor 1403. Instructions 1407b and/or data 1409b loaded into the processor 1403 may also include instructions 1407a and/or data 1409a from memory 1405 that were loaded for execution or processing by the processor 1403. The instructions 1407b may be executed by the processor 1403 to implement the methods described above.

The eNB 1460 may also include a housing that contains one or more transmitters 1417 and one or more receivers 1478 to allow transmission and reception of data. The transmitter(s) 1417 and receiver(s) 1478 may be combined into one or more transceivers 1476. One or more antennas 1480a-n are attached to the housing and electrically coupled to the transceiver 1476.

The various components of the eNB 1460 are coupled together by a bus system 1411, which may include a power bus, a control signal bus and a status signal bus, in addition to a data bus. However, for the sake of clarity, the various buses are illustrated in FIG. 17 as the bus system 1411. The eNB 1460 may also include a digital signal processor (DSP) 1413 for use in processing signals. The eNB 1460 may also include a communications interface 1415 that provides user access to the functions of the eNB 1460. The eNB 1460 illustrated in FIG. 17 is a functional block diagram rather than a listing of specific components.

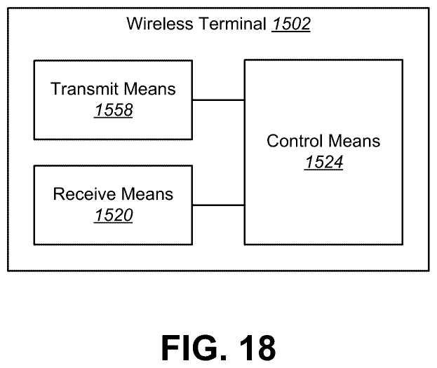

FIG. 18 is a block diagram illustrating one implementation of a wireless terminal 1502 in which systems and methods for resource allocations of enhanced uplink transmissions may be implemented. The wireless terminal 1502 includes transmit means 1558, receive means 1520 and control means 1524. The transmit means 1558, receive means 1520 and control means 1524 may be configured to perform one or more of the functions described herein. FIG. 16 above illustrates one example of a concrete apparatus structure of FIG. 18. Other various structures may be implemented to realize one or more of the functions herein. For example, a DSP may be realized by software.

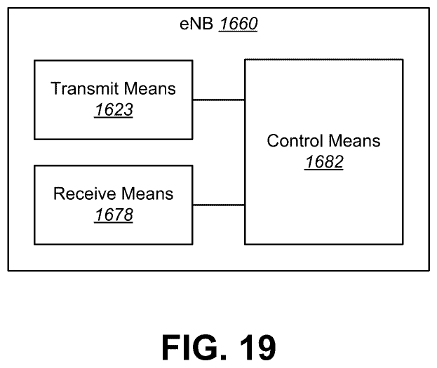

FIG. 19 is a block diagram illustrating one implementation of a eNB 1660 in which systems and methods for resource allocations of enhanced uplink transmissions may be implemented. The eNB 1660 includes transmit means 1623, receive means 1678 and control means 1682. The transmit means 1623, receive means 1678 and control means 1682 may be configured to perform one or more of the functions described herein. FIG. 17 above illustrates one example of a concrete apparatus structure of FIG. 19. Other various structures may be implemented to realize one or more of the functions described herein. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB or the wireless terminal according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or Hard Disk Drives (HDDs), and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB and the wireless terminal according to the systems and methods described above may be realized as an LSI that is a typical integrated circuit. Each functional block of the gNB and the wireless terminal may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. An internet of things (IoT) non-terrestrial network (NTN) device user equipment (UE), comprising:
receiving circuitry configured to:
receive configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4;
receive a separately configured orthogonal cover code radio network temporary identifier (OCC-RNTI) and/or a number of repetitions table for a repetition number field in downlink control information (DCI) format 0;
receive a DCI format N0 for a NPUSCH transmission with an OCC index indication; and
transmitting circuitry configured to:
transmit an NPUSCH with OCC multiplexing with the provided OCC multiplexing factor and the indicated OCC index on a schedule resource.

2. The UE of claim 1, wherein if the OCC multiplexing factor is 2, the OCC index is provided by the two most significant bits in a subcarrier indication field, with 00 for OCC index 0 and 11 for OCC index 1.

3. The UE of claim 1, wherein if the OCC multiplexing factor is 2, the OCC index is provided by the most significant bits in a subcarrier indication field, with 0 for OCC index 0 and 1 for OCC index 1.

4. The UE of claim 1, wherein if the OCC multiplexing factor is 2 and if separately configured number of repetitions table comprises 4 entries, the OCC index is provided by the most significant bits in the repetition number field, with 0 for OCC index 0 and 1 for OCC index 1.

5. The UE of claim 1, wherein if the OCC multiplexing factor is 2 and if a separate OCC-RNTI is configured, an OCC index 0 is indicated by scrambling a cyclic redundancy check (CRC) with a legacy cell radio network temporary identifier (C-RNTI) in the DCI format N0, and an OCC index 1 is indicated by scrambling the CRC with a new OCC-RNTI in the DCI format N0.

6. An e-NodeB (eNB), comprising:
transmitting circuitry configured to:
transmit to an internet of things (IoT) non-terrestrial network (NTN) device user equipment (UE) the configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4;
transmit configurations on a separately configured orthogonal cover code radio network temporary identifier (OCC-RNTI) and/or a number of repetitions table for a repetition number field in downlink control information (DCI) format 0;
transmit a DCI format N0 for a NPUSCH transmission with an OCC index indication; and
receiving circuitry configured to:
receive an NPUSCH with OCC multiplexing with the provided OCC multiplexing factor and the indicated OCC index on a schedule resource.

7. The eNB of claim 6, wherein if the OCC multiplexing factor is 2, the OCC index is provided by the two most significant bits in a subcarrier indication field, with 00 for OCC index 0 and 11 for OCC index 1.

8. The eNB of claim 6, wherein if the OCC multiplexing factor is 2, the OCC index is provided by the most significant bits in a subcarrier indication field, with 0 for OCC index 0 and 1 for OCC index 1.

9. The eNB of claim 6, wherein if the OCC multiplexing factor is 2 and if separately configured number of repetitions table comprises 4 entries, the OCC index is provided by the most significant bits in the repetition number field, with 0 for OCC index 0 and 1 for OCC index 1.

10. The eNB of claim 6, wherein if the OCC multiplexing factor is 2 and if a separate OCC-RNTI is configured, an OCC index 0 is indicated by scrambling a cyclic redundancy check (CRC) with a legacy cell radio network temporary identifier (C-RNTI) in the DCI format N0, and an OCC index 1 is indicated by scrambling the CRC with a new OCC-RNTI in the DCI format N0.

11. A method by an internet of things (IoT) non-terrestrial network (NTN) device user equipment (UE), comprising:
receiving configurations on orthogonal cover code (OCC) multiplexing support and OCC multiplexing factor for narrowband internet of things (NB-IoT) narrowband physical uplink shared channel (NPUSCH) in a higher layer signaling, wherein the OCC multiplexing factor is selected from the group consisting of 2 or 4;
receiving a separately configured orthogonal cover code radio network temporary identifier (OCC-RNTI) and/or a number of repetitions table for a repetition number field in downlink control information (DCI) format 0;
receiving a DCI format N0 for a NPUSCH transmission with an OCC index indication; and
transmitting an NPUSCH with OCC multiplexing with the provided OCC multiplexing factor and the indicated OCC index on a schedule resource.
